(19) United States
(12) Patent Application Publication
(10) Pub. No.: US 2005/0007059 A1
(43) Pub. Date: Jan. 13, 2005

(54) Damper system

(76) Inventors: Chee Meng Chew, Singapore (SG); Geok Soon Hong, Singapore (SG); Wei Zhou, Singapore (SG)

Correspondence Address: DINSMORE & SHOHL LLP, One Dayton Centre, One South Main Street, Suite 500, Dayton, OH, 45402-2023, US

(21) Appl. No.: 10/845,787

(22) Filed: May 13, 2004

Related U.S. Application Data
(60) Provisional application No. 60/469,825, filed on May 13, 2003.

(51) Int. Cl. F16D 33/00

(52) U.S. Cl. 318/623

(57) ABSTRACT

An output force from a system (10) comprising a damper (22) and a power drive (20) is controlled using feedback (34) from the output of the damper (22) relative to the input to the damper (22). By adopting a damper (22) with a variable damping coefficient and controlling that coefficient, the system (10) can achieve force/torque performance over a wide range of force values, with low output impedance and a large bandwidth. The damper (22) also serves as an impact absorption device to protect the power drive (20) from external impact.

### FIELD OF THE INVENTION

The present invention relates to a damper system and, in particular, a damper system for controlling a force output, for instance to be used in series with a power drive.

### BACKGROUND OF THE INVENTION

There are several ways to control a force output of a system. For instance, a force signal can be obtained through the use of a strain gauge set-up and the output force controlled through the feeding back of the force signal. However, the inherent low signal-to-noise ratio of such an approach makes implementation difficult to achieve. Furthermore, the strain gauge set-up has high structural stiffness and is not suitable for many systems that need frequently to interact with an unknown environment.

Another method to control the output force of a system is discussed in U.S. Pat. publication No. 5,650,704, issued on 22 Jul. 1997 to Praft et al. U.S. Pat. No. 5,650,704 describes an elastic actuator consisting of a motor with a motor drive transmission connected at an output of the motor. An elastic element, such as a linear spring or a torsional spring, is connected in series with the motor drive transmission. A single force transducer is positioned at a point between a mount for the motor and an output of the actuator. This force transducer generates a force signal, based on deflection of the elastic element, which indicates the force applied by the elastic element to the output of the actuator. Motor force control is achieved through an active feedback force control loop that is connected between the force transducer and the motor. This motor control is based on the force signal, to deflect the elastic element an amount that produces a desired actuator output force.

However, introducing an elastic element increases the system order. Consequently, the bandwidth and the stability margin of the system are reduced. In choosing the type of elastic element for use in the actuator system, there is a trade-off between the system bandwidth, the force range and the impact tolerance. In addition, once the type of elastic element is chosen, it is difficult or impossible to vary the elastic property of the elastic element. As a result, it is difficult to achieve good force fidelity over a wide force range.

### SUMMARY OF THE INVENTION

According to one aspect of this invention, there is provided a damper system. The damper system comprises a damper for producing an output force based on an input; a sensor for providing a sensor signal indicative of the damper output force; and a system controller. The system controller is for controlling the output from the damper, based on the sensor signal to provide a predetermined damper output force.

According to another aspect of the invention, there is provided a method of controlling the output of a damper system comprising a damper for producing an output based on an input. The method comprises providing a sensor signal indicative of the damper output force; and controlling the output from the damper, based on the sensed difference to provide a predetermined damper output force.

According to again another aspect of the invention, there is provided a series damper actuator comprising: a motor, a damper, a sensor and a feedback force controller. The damper is connectable in series with the motor to separate the motor from a load. The sensor is for measuring the relative velocity in the damper and generating a sensor signal therefrom. The controller is connectable between the sensor and the motor for controlling the motor, based on the sensor signal, to achieve desired relative velocity in the damper and, therefore, to produce a desired actuator output force.

For example, in an embodiment an output force from a system comprising a damper and a power drive is controlled using feedback from the output of the damper relative to the input to the damper. By adopting a damper with a variable damping coefficient and controlling that coefficient, the system can achieve excellent linear force/torque performance over a wide range of force values, with low output impedance and a large bandwidth. The damper also serves as an impact absorption device to protect the power drive from external impact.

### BRIEF DESCRIPTION OF THE DRAWINGS

The present invention is further described by way of non-limitative example, with reference to the accompanying claims, in which:—

FIG. 1 is the schematic diagram of a damper system according to an embodiment of the invention;

FIG. 2 is the cross-sectional view of a series damper actuator, for instance for use in the embodiment of FIG. 1;

FIG. 3 is a flowchart exemplifying an operation of the system of FIG. 1;

FIGS. 4A and 4B are graphs showing output torques against two different input reference torques under first conditions;

FIGS. 5A and 5B are graphs showing output torques against two different input reference torques under second conditions; and

FIG. 6 is a flowchart exemplifying an operation of an alternative system.

### DETAILED DESCRIPTION OF THE INVENTION

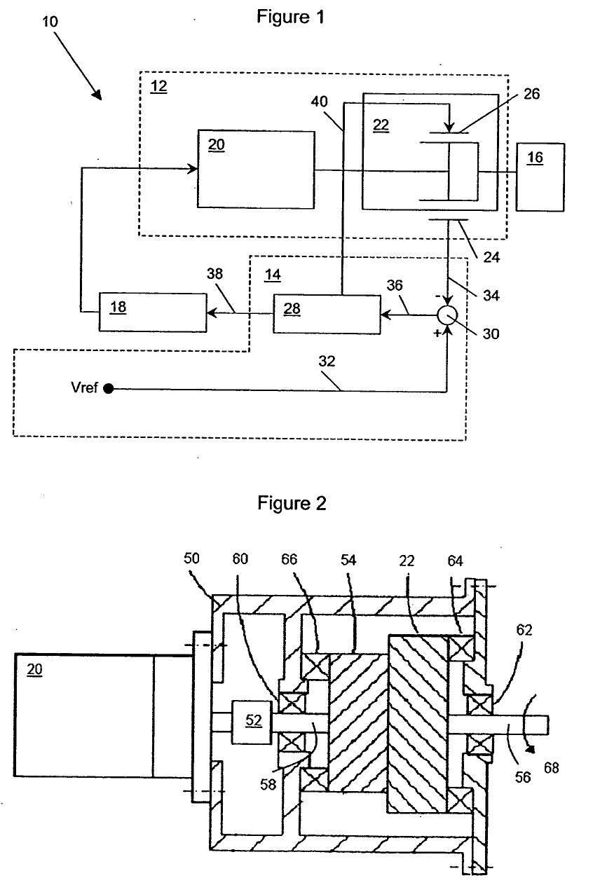

FIG. 1 is a schematic diagram of a series damper actuator system 10 according to an embodiment of the invention. This figure depicts a system that is divided into two main parts: a rotary series damper actuator 12 and a control board 14. A rotary load 16 is mounted on the series damper actuator 12. An amplifier 18 is mounted between the series damper actuator 12 and the control board 14.

The series damper actuator 12 comprises a rotary power drive 20, a rotary damper 22, a damper sensor 24 and a damper controller 26. The power drive 20 may include a gear transmission and is, in this embodiment, a motor. The output of the power drive 20 is rotary and is connected to the input of the damper 22. The output of the damper 22 is rotary and is connected to the load 16. The damper could, for instance, be of a type described in U.S. Pat. publication No. 6,095,295, issued on 1 Aug. 2000 1997 to Park et al., entitled Rotary Damper.

The control board 14 is, in effect, a feedback force controller and comprises a system controller 28, a comparator 30 and a reference signal (Vref) 32. The reference signal (Vref) 32 may be constant or varying, for instance sinusoidally or in a step function. The comparator 30 compares the reference signal 32 with a sensor signal 34, output from the damper sensor 24 in the series damper actuator 12. The output of the comparator 30 is an error signal 36, which is an input to the system controller 28. One output from the system controller 28 is a power drive control signal 38, based on the input error signal 36. The power drive control signal 38 is input to the amplifier 18, which amplifies that control signal 38 to control the power drive 20. The power drive control signal 38 is a power signal in this embodiment, to control the speed of rotation of the power drive 20. In this embodiment, another output from the system controller 28 is a damper control signal 40 for sending to the damper controller 26 to modulate the damping coefficient of the damper 22.

The damper 22 in this embodiment has a known, substantially linear relationship between the damper force and the relative velocity of the two ends. The damping coefficient of the damper 22 is adjustable and controllable by the damper controller 26. The damper 22 provides good impact absorption and reduces the rate of wear experienced by the power drive 20 and other components that to which the power drive 20 may be connected.

The damper sensor 24 produces the sensor signal 34 comprising data regarding the relative velocities at the input and output of the damper 22. The sensor signal 34 passes to the control board 14 through closed loop feedback The sensor 24 may, for instance, be a force transducer. This may be implemented by way of positions sensors mounted across the two ends of the damper 22. The position information can be used to determine the relative velocity between the input and the output of the damper 22. Using the relative velocity data, the output force of the series damper actuator 22 can be found, by way of the following equation 1 (assuming the damping coefficient b is known):
F=b×Δv (equation 1)
where,
F is the output force of the damper 22,
Δv is the relative velocity between the input and the output of the damper 22, and
b is the damping coefficient of the damper 22 at a particular instant.

For a rotational damper, the more correct form is:
T=b×Δω
where
T is the output torque of the damper 22,
Δω is the relative rotational velocity between the input and the output of the damper 22, and
b is the rotary damping coefficient of the damper 22 at a particular instant. However, in the following description, the general form, of equation 1, is used when referring to both linear or rotational systems.

Thus for a known damping coefficient, a desired system output force can be achieved by a particular velocity difference. Thus, for a desired output force, there is a target velocity difference.

Based on the error signal 36, from comparing the sensor signal 34 with the reference signal 32, the system controller 28 can be used to increase or decrease the input velocity to the damper 22, so as to achieve the target relative velocity (Δv) in the damper 22. Thus, the desired output force of the entire system can be achieved. The reference signal 32 that gives rise to the error signal 36 is varied according to the desired output force or torque from the damper 22.

One exemplary type of system controller 28 is a PID (proportional, integrate and derivative) controller. Given the error signal (e) 36, a drive signal (u) 38 can be calculated based on the following follow equation, with the aim of minimising the error signal (e) 36:

$$u = {k}_{P} e + {k}_{I} {\int }_{0}^{t} e \cdot ⅆ t + {k}_{D} \frac{ⅆ e}{ⅆ t}$$

where
k_{P}, k_{I} and k_{D} are parameters of the PID controller; and
t is the time that has elapsed so far.

The current of the power drive 20 is controlled based on the drive signal (u) 38, according to the following relationship:
F=k_{pd}*u
where k_{pd} is a constant associated with the power drive 20 (and also the amplifier 18 in the embodiment of FIG. 1).

More specifically, for a rotary drive, T=k_{pd}*u.

A PID controller is just one of many control approaches that can be used to obtain the drive signal to minimise the error signal. Other controllers may include Adaptive Control, Neural Control, Fuzzy Logic Control, etc. Whilst a PID produced signal is used to control the power drive by controlling the input current supply, the results from other methods can be used to control the input voltage supply to the power drive 20.

The damper 14 according to this main embodiment has a magneto-rheological fluid, which has a controllable damping coefficient. The system controller 28 controls the damping coefficient of the damper 22 by issuing commands to the damper controller 26, which generates a magnetic field or changes the strength of a magnetic field to increase or reduce the coefficient as desired, according to the general magnitude of the desired output force (since it might, otherwise, not be achievable by controlling the speed difference alone). The damper 22 behaves like a viscous damper with a linear relationship between the damper torque and the relative velocity. The system controller 28 can also increase or decrease the damping coefficient of the damper when the damper experiences a large or small force, respectively. Thus, good force fidelity is possible for a wide range of forces. Whilst the damping coefficient is constant, the damper does not increase the order of the overall system. Hence the stability margin of the system is not significantly affected.

FIG. 2 shows a series damper actuator 12 according to an embodiment. The rotary power drive 20 is mounted at one end of a body 50, for instance a supporting shell. The rotary damper 22 is mounted within the body 50 at the other end of the shell 50 from that to which the power drive 20 is mounted. The power drive 20 is connected to the damper 22 through a coupler 52 and the sensor, in the form of an angular position sensor 54, for example a rotary encoder. An output shaft 56 extends from the output of the damper 22. The damper controller is not shown in this FIG. 2. An input shaft 58 to the damper 22 and the output shaft 56 are mounted on a set of bearings 60, 62 each. The damper 22 and the sensor 54 are mounted between two sets of thrust bearings 64, 66.

The angular position sensor 54 is mounted between the input and output shafts 58, 56 of the damper 22, so that the relative angular position of the damper 22 can be obtained. After differentiating the relative angular position of the rotary damper 22, the relative angular velocity of the rotary damper 22 can be obtained. Since the damping coefficient of the damper 22 is known, the torque 68 generated at the output of the series damper power drive 20 can be calculated.

All the system components shown in FIG. 2 are connected to and supported by the body 50, which is used to hold and encapsulate the damper 22 and the angular sensor 54. The body 50, rather than the power drive 20, also supports the stress created along the output shaft 56, which is generated by the load connected to the output of the damper 22. This stress is transferred to the body 50 through the use of the two sets of thrust bearing 64, 66. Further, the body 50 encases and shields the components from the environment, thus making the system more reliable and durable.

Two encoders may be used to measure the input and the output velocities of a Damper 14, respectively. The relative velocity in the damper can then be obtained from the difference of these two measurements in a decoder. Although one encoder is sufficient to measure the relative velocity between the input velocity and the output velocity of a damper, using two encoders to obtain this relative velocity allows for a system controller that can implement better force control.

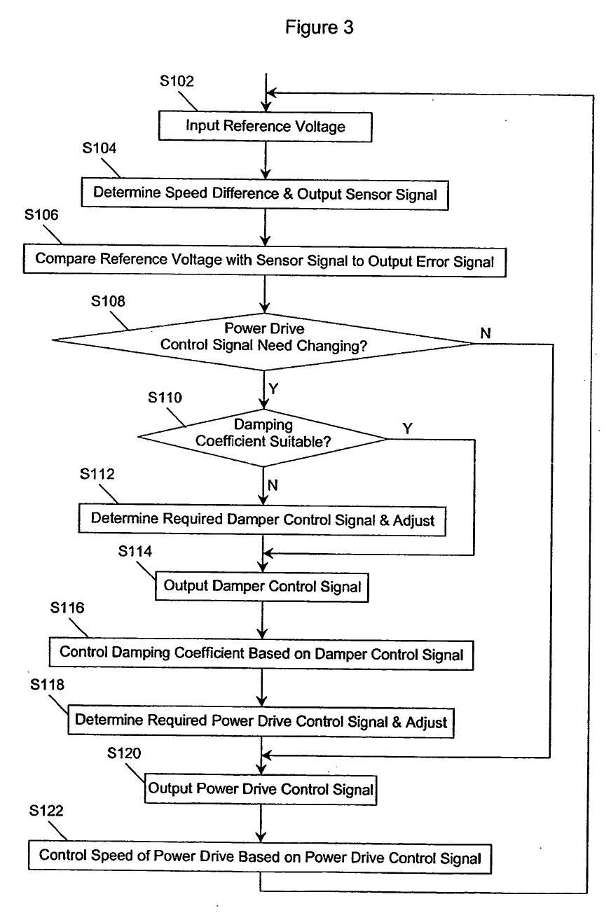

FIG. 3 is a flowchart exemplifying the operation of the system 10 of FIG. 1. The reference voltage 32 is input (step S102). The speed difference between the input and output of the damper 22 is determined by the sensor 24 and the sensor output signal 34 is output (step S104). The reference voltage 32 and the sensor output signal 34 are compared by the comparator 30 to output the error signal 36 (step S106). A determination is made as to whether the current power drive control signal 38 needs changing as a result of the error signal 36 (step S108). The power drive control signal 38 needs changing generally if the error signal is not zero or departs to a significant degree beyond zero (which degree depends on the sensitivity of the system and the allowable error).

If the power drive control signal 38 does need changing, a determination is made as to whether the current damping coefficient is suitable given the desired output, based on the reference signal 32 (step S110). The velocity difference (Δv) required to achieve a specific force may be so large that the system is incapable of running the power drive at such a speed, or such that it could mean running the power drive at an undesirable or inefficient speed. Given that, for a linear relationship as in equation 1 above and for most, if not all, non-linear relationships between the force and the speed difference, the function is a positive one, increasing the damping coefficient will have the effect of decreasing the speed difference needed for a desired output force.

If the damping coefficient needs changing, a required damper control signal 40 is determined based on the allowable speeds of the power drive and the damper control signal 40 is adjusted accordingly (step S112). The damper control signal is output (step S114). The damper control signal that is output is the adjusted damper control signal if the determination in step S110 is that the current damping coefficient is not suitable. If the determination in step S110 is that the current damping coefficient is suitable, the process passes from step S10 to step S114 without adjusting the damper control signal. Based on the output damper control signal, the damping coefficient of the damper is controlled (step S116), to change or stay the same, as appropriate.

A suitable new power drive control signal 38 is also determined based on the error signal 36 and the current damping coefficient (which may already have been adjusted in this iteration of the process) and the power drive control signal 38 is adjusted accordingly (step S118).

The current control signal 38 is output (step S120). If the control signal was adjusted in step S118, the control signal 38 that is output is the adjusted control signal. On the other hand, if the determination in step S108 is that the control signal does not need changing, the process passes from step S108 to step S120 without adjusting the power drive control signal 38. Based on the output control signal in step S120, the speed of the power drive is controlled (step S122), to change or stay the same, as appropriate.

The process reverts to step S102 to be repeated.

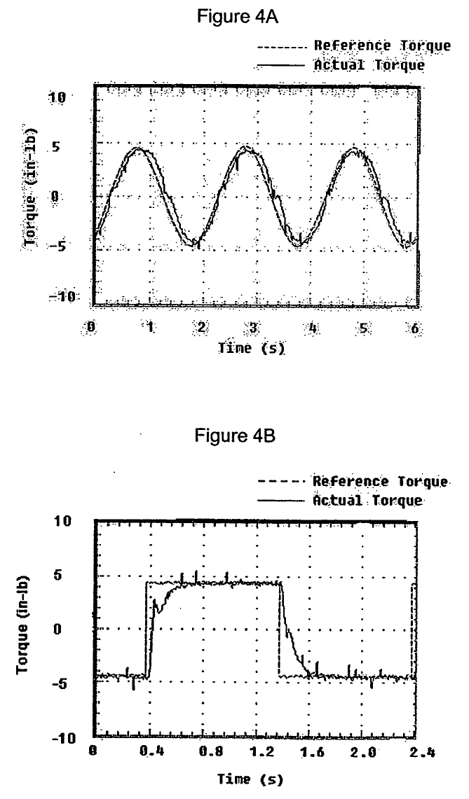

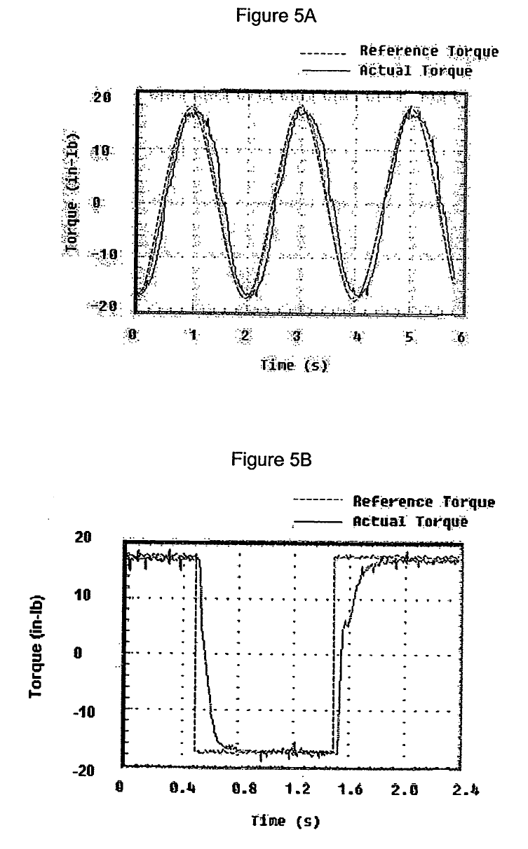

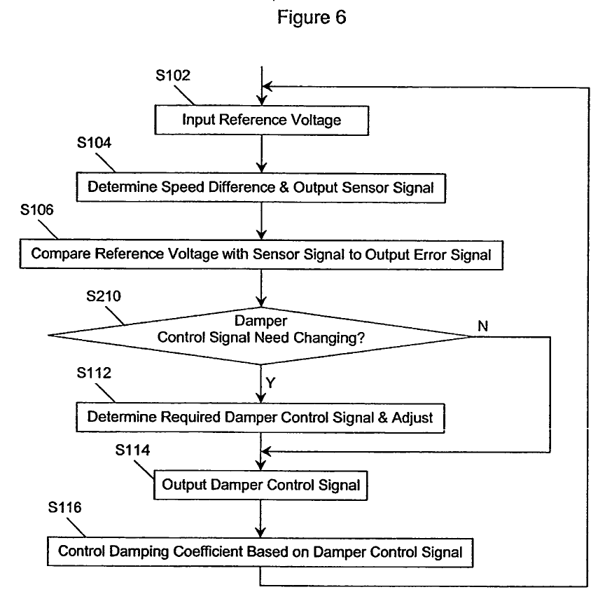

The results of experiments conducted to determine the torque control performance of the embodiment of FIG. 1 are shown in FIGS. 3 and 4. FIG. 4A shows the torque response for a sinusoidal reference torque when the damping coefficient was set at b=0.18 NmS. FIG. 4B shows the torque response for a square wave reference torque when the damping coefficient was also set at b=0.18 NmS. The amplitude of both of these reference torques was set at 4.5 in-lbs (0.51 Nm). FIGS. 5A and 5B show the torque responses to the sinusoidal and square wave reference inputs, respectively when the damping coefficient of the damper was doubled (i.e. set at b=0.36 NmS). The amplitude of both reference torques was quadrupled, to 18 in-lbs (2.0 Nm). The results shown in FIGS. 3 and 4 indicate that the damper actuator system can achieve good torque control performance. Further, by allowing the system controller to control the damping coefficient, good torque control performance is possible across a broad range of input forces.

In the above-described embodiment, the actuator system 10 produces a rotary output. This uses a rotary input to the damper 22, whether from a motor (e.g. electric, hydraulic, pneumatic, e.g.), an engine, an actuator or some other power drive. The power drive may, itself produce a linear motion directly which is then converted to rotary motion for input to the damper.

In an alternative embodiment the output from the actuator system is linear motion. This can be achieved using linear motion input to the damper and the damper being a linear one to output linear motion. For such a system the power drive would typically be a linear actuator, although it would be possible for the power drive to produce a rotary motion which is converted to a linear motion for input to the damper. In equation 1 above, the force would be a linear force, the damping coefficient, the damping coefficient for linear motion and the speed difference would be a difference in linear speed.

The ability to vary the damping coefficient of the damper, controllably, is preferred. Where the ability to vary the damping coefficient is present, it is useful in broadening the range of use for any one damper system. In the main described embodiment, the coefficient is changeable by way of a magnetic field, due to the use of a magneto-rheological viscous fluid. These are typically stable suspensions of magnetically polarisable micron sized particles suspended in a low volatility carrier fluid, usually a synthetic hydrocarbon, although other hydrocarbons, silicone or water are other known possibilities.

In other embodiments, the fluid may be electro-rheological fluid, whose viscosity varies with the strength of an electric field or electro- and magneto-rheological (EMR) fluids which can be polarised by both an electric field and an magnetic field. Examples of such EMR fluids include titanium-coated iron particles in oil or high T_c superconducting particles in liquid nitrogen. Other approaches may include heating or cooling a viscous fluid to change the damping coefficient or changing an orifice size in the damper to change the speed at which the piston or rotor passes through the relevant chamber. Other ways of changing the damping coefficient will also fall within the knowledge of the skilled person.

The power drive used depends on the needs of the specific application. Examples of power drives include: electric motors, hydraulic motors, pneumatic motors, rotary actuators, linear actuators, etc.

The sensors used may include: potentiometers, optical sensors, transducers, tachometers, position sensors, linear variable differential transducers, etc. The main embodiment uses the sensors to determine a speed difference across the damper. Alternatively, the sensor can be used to determine the output force directly, for instance using a strain gauge or piezoelectric component, or other suitable means. If the actual output force is known, then the velocity change needed to achieve the target output force can be determined, and the power drive controlled accordingly. Instead of the output force, the system may determine the input force, as the input and output forces are substantially the same, and use the determined input force to determine the velocity change needed to achieve the target output force. Various measurements may be combined for greater accuracy, e.g. a speed difference and/or the output force and/or the input force.

The controller board can be implemented using dedicated analogue or digital circuits or a processor with software, etc.

In the main embodiment, the damping coefficient is adjustable. In an alternative embodiment it is not adjustable but is substantially constant. In such an embodiment, there is no need for the damper control signal 40 or the damper controller 26.

The relationship between the output force of the damper, the speed difference across the damper and the damping coefficient of the damper 22 in the above embodiment is a linear relationship. The relationship may be generalised to
F=f(Δv),
where the damping coefficient corresponds to the slope of the function f, that is

$$b = \frac{ⅆ f ( Δ v )}{ⅆ Δ v} = {f}^{′} ( Δ v )$$

which also covers non-linear relationships. However, the relationship is generally known, even if only for certain specific values it is only determined experimentally.

For a non-linear relationship between the force and the speed difference across the damper, the relationship can be represented by a curve, the gradient of which represents the damping coefficient. The damping coefficient may, usefully, increase with the force. One such suitable profile is a cubic curve passing through the origin and which is symmetric about the origin (i.e. the values are the same in either movement direction), with speed differences in the x-axis and output force in the y-axis. Where such a curve is generally flat for low forces (i.e. there is a low damping coefficient), the system would be sensitive, producing relatively small force changes for large changes in the speed difference. The curve might then be steep for higher speed differences, requiring small speed difference changes for large output force changes. This results in a reasonably large available force range, without needing to vary the non-linear relationship between the output force and the speed difference across the damper.

Where the relationship between the force and the speed difference is linear, the damping coefficient may only need changing where the drive speeds required for a particular force would otherwise be undesirable high or low or not possible. For a non-linear relationship between the force and the speed difference, the damping characteristic (F vs Δv or function f) can be designed such that the slope of f is steep at a high force range and gentle at a low force range. This will allow the overall system to have good force fidelity at both high and low force ranges. Conversely, the damping coefficient can be adjusted to keep the function in a particular force range for a particular speed difference range, if it is desired.

The described systems have many uses where force control is desired. Examples of application areas include manipulators, walking robots, haptic devices, simulators, etc. The system is especially useful where it is desirable to introduce some kind of shock absorption between a load and an actuator. For example, the gear transmission of an electric motor can break down quite quickly if there is no impact absorption between it and a load. The damper system described are particularly useful in systems that are to interact frequently with an unknown environment, especially if the amplitude of output forces can change of a wide range.

Whilst limited embodiments have been described, the skilled person will recognise that the invention need not be limited to the specific embodiments, except insofar as any component is specifically indicated as essential and that various alterations can be made without departing from what has been invented.

1. A damper system comprising:
a damper for producing an output force based on an input;
a sensor for providing a sensor signal indicative of the damper output force; and
a controller for controlling the input to the damper, based on the sensor signal, to provide a predetermined damper output force.

2. A system according to claim 1, wherein the damper has a damping coefficient and the controller further comprises a damper controller for controllably changing the damping coefficient of the damper.

3. A system according to claim 2, wherein the damper controller is operable to change the damping coefficient of the damper based on the sensor signal.

4. A system according to claim 2, wherein the damper controller is operable to control the viscosity of a fluid in the damper.

5. A system according to claim 4, wherein the fluid is a magneto-rheological fluid and the damper controller is operable to change a magnetic field to change the viscosity of the fluid.

6. A system according to claim 4, wherein the fluid is an electro-rheological fluid and the damper controller is operable to change an electric field to change the viscosity of the fluid.

7. A system according to claim 2, wherein the damper controller is operable to control the damping coefficient by controlling the size of an orifice in the damper.

8. A system according to claim 1, wherein the sensor is operable to determine a difference between the damper input and output.

9. A system according to claim 8, wherein the sensor is operable to determine a speed difference between an input to the damper and an output from the damper.

10. A system according to claim 1, wherein the sensor is operable to measure the output force from the damper.

11. A system according to claim 1, wherein the sensor is operable to measure the input force to the damper.

12. A system according to claim 1, wherein the output force comprises a torque.

13. A system according to claim 1, wherein the output force comprises a linear force.

14. A system according to claim 1, wherein the damper has a linear relationship between the output force and the difference in speed between the damper input and output.

15. A system according to claim 1, wherein the damper has a non-linear relationship between the output force and the difference in speed between the damper input and output.

16. A system according to claim 15, wherein the non-linear relationship between the output force and the difference in speed between the damper input and output is cubic.

17. A system according to claim 1, wherein the controller comprises a system controller for controlling an input speed to the damper.

18. A system according to claim 1, wherein the controller comprises a system controller for controlling an input force to the damper.

19. A system according to claim 1, further comprising a comparator for comparing the sensor signal with a reference signal, and wherein the controller is operable to control the input to the damper based on the result of the comparison between the sensor signal and the reference signal.

20. A system according to claim 1, further comprising a power drive for providing the input force to the damper.

21. A system according to claim 20, wherein the controller is operable to control the input to the damper by controlling the power drive.

22. A system according to claim 21, wherein the controller is operable to control the input to the damper by controlling the speed of the power drive.

23. A system according to claim 21, wherein the controller is operable to control the input to the damper by controlling the current into the power drive.

24. A system according to claim 21, further comprising a comparator for comparing the sensor signal with a reference signal, and wherein
the controller is operable to control the input to the damper based on the result of the comparison between the sensor signal and the reference signal; and
the system controller is operable to provide a control signal u to control the power drive derived as follows:
$$u = {k}_{P} e + {k}_{I} {\int }_{0}^{t} e \cdot ⅆ t + {k}_{D} \frac{ⅆ e}{ⅆ t}$$
where
e is the result of the comparison between the sensor signal and the reference signal;
k_{P}, k_{I} and k_{D} are parameters of the controller; and
t is the time that has elapsed so far.

25. A system according to claim 21, wherein the controller is operable to control the input to the damper by controlling the voltage into the power drive.

26. A system according to claim 20, wherein the power drive comprises a rotary power drive.

27. A system according to claim 20, wherein the power drive comprises a linear power drive.

28. A series damper actuator comprising:
a damper for producing an output force based on an input;
a sensor for providing a sensor signal indicative of the damper output force;
a controller for controlling the input to the damper, based on the sensor signal, to provide a predetermined damper output force; and
a power drive for providing the input force to the damper, mounted in series with the damper.

29. An actuator according to claim 28, further comprising a load and wherein the damper separates the power drive from the load so as to protect the power drive from external impact.

30. A method of controlling the output of a damper system comprising a damper for producing an output force based on an input, the method comprising:
providing a signal indicative of the damper output force; and
controlling the input to the damper, based on the signal, to provide a predetermined damper output force.

31. A method according to claim 30, wherein the damper has a damping coefficient and further comprising controllably changing the damping coefficient of the damper.

32. A method according to claim 31, wherein controllably changing the damping coefficient comprises changing the damping coefficient of the damper based on the sensor signal.

33. A method according to claim 31, wherein controlling the damping coefficient of the damper comprises changing the viscosity of a fluid in the damper.

34. A method according to claim 33, wherein the fluid is a magneto-rheological fluid and controlling the damping coefficient of the damper comprises changing a magnetic field to change the viscosity of the fluid.

35. A method according to claim 33, wherein the fluid is an electro-rheological fluid and controlling the damping coefficient of the damper comprises changing an electric field to change the viscosity of the fluid.

36. A method according to claim 31, wherein controlling the damping coefficient of the damper comprises controlling the size of an orifice in the damper.

37. A method according to claim 30, wherein providing a sensor signal further comprises determining a difference between the damper input and output.

38. A method according to claim 37, wherein providing a sensor signal further comprises determining speed difference between an input to the damper and an output from the damper.

39. A method according to claim 30, wherein providing a sensor signal further comprises measuring the output force from the damper.

40. A method according to claim 30, wherein providing a sensor signal further comprises measuring the input force from the damper.

41. A method according to claim 30, wherein the output force comprises a torque.

42. A method according to claim 30, wherein the output force comprises a linear force.

43. A method according to claim 30, wherein the damper has a linear relationship between the output force and the difference in speed between the damper input and output.

44. A method according to claim 30, wherein the damper has a non-linear relationship between the output force and the difference in speed between the damper input and output.

45. A method according to claim 44, wherein the non-linear relationship between the output force and the difference in speed between the damper input and output is cubic.

46. A method according to claim 30, wherein controlling the input to the damper comprises controlling the input speed to the damper.

47. A method according to claim 30, wherein controlling the input to the damper comprises controlling a force input to the damper.

48. A method according to claim 30, further comprising comparing the sensor signal with a reference signal, and wherein controlling the input to the damper is based on the result of the comparison between the sensor signal and the reference signal.

49. A method according to claim 30, wherein controlling the input to the damper comprises controlling the output from a power drive to the damper.

50. A method according to claim 49, wherein controlling the input to the damper comprises controlling the speed of the power drive.

51. A method according to claim 49, wherein the power drive comprises a rotary power drive.

52. A method according to claim 49, wherein the power drive comprises a rotary power drive.

53. A method according to claim 30, further comprising mounting the damper system between the power drive and a load to protect the power drive from external impact on the load.

54. A series damper actuator comprising:
a motor;
a damper, connectable in series with the motor, to separate the motor from a load;
a sensor for measuring the relative velocity in the damper and generating a sensor signal therefrom; and
a feedback force controller connectable between the sensor and the motor for controlling the motor, based on the sensor signal, to achieve desired relative velocity in the damper and, therefore, to produce a desired actuator output force.
